(19) United States
(12) Patent Application Publication
(10) Pub. No.: US 2025/0376355 A1
(43) Pub. Date: Dec. 11, 2025

(54) SAFETY DETECTION DEVICE AND ESCALATOR OR MOVING WALKWAY INCORPORATING THE DEVICE

(71) Applicant: Otis Elevator Company, Farmington, CT (US)

(72) Inventors: Xinwei Gong, Haining (CN); Lifei Cheng, Hangzhou (CN)

(21) Appl. No.: 19/222,172

(22) Filed: May 29, 2025

(30) Foreign Application Priority Data
Jun. 5, 2024 (CN) 202410725035.5

(51) Int. Cl. B66B 29/00

(52) U.S. Cl. CPC B66B 29/00

(57) ABSTRACT

A safety detection device includes a first switch connected to a power supply, and which will switch from a first state to a second state when an abnormal event occurs. The safety detection device further includes an excitation unit which, in an energized state, will cause the first switch to switch from the first state to the second state. A second switch is also connected between the power supply and the excitation unit. In a first mode, a controller of the safety detection device disconnects a connection between the power supply and the excitation unit by controlling the second switch and determines whether the abnormal event occurs. In a second mode, the controller connects the power supply with the excitation unit by controlling the second switch, and determines whether a function of the first switch is normal based on the voltage at the other end of the first switch.

### FOREIGN PRIORITY

This application claims priority to Chinese Patent Application No. 202410725035.5, filed Jun. 5, 2024, and all the benefits accruing therefrom under 35 U.S.C. § 119, the contents of which in its entirety are herein incorporated by reference.

### TECHNICAL FIELD OF INVENTION

The present disclosure relates to elevator technology and, in particular, to a safety detection device for an escalator or moving walkway and an escalator or moving walkway comprising the device.

### BACKGROUND OF THE INVENTION

Floor switches or front panel open switches are important safety components in escalators, which are typically located under a front panel or cover plate above a bottom control cabinet, motor box, or main drive device of the escalator. In response to an abnormal event where the front panel or cover plate is opened, the floor switch will cause the escalator to stop operation to prevent further damage or injury. A normal function of the floor switch is a requisite condition for ensuring passenger safety and normal operation of the escalator, so it is urgently needed to timely and accurately detect switch faults.

### SUMMARY OF THE INVENTION

In accordance with an aspect of the present disclosure, a safety detection device for an escalator or moving walkway and an escalator or moving walkway comprising the device are provided.

In accordance with an aspect of the present disclosure, a safety detection device for an escalator or moving walkway comprises a first switch, which is provided under a cover plate and one end of which is connected to a power supply, and which will switch from a first state to a second state when an abnormal event occurs. The safety detection device further comprises an excitation unit which, in an energized state, will cause the first switch to switch from the first state to the second state. A second switch is also connected between the power supply and the excitation unit. In a first mode, a controller of the safety detection device disconnects a connection between the power supply and the excitation unit by controlling the second switch and determines whether the abnormal event occurs based on a voltage at other end of the first switch. Further, in a second mode, the controller connects the power supply with the excitation unit by controlling the second switch, and determines whether a function of the first switch is normal based on the voltage at the other end of the first switch.

In the safety detection device, the first switch may comprise a normally closed contact and a triggering mechanism. When the abnormal event occurs, the triggering mechanism will cause the normally closed contact to disconnect, causing the first switch to switch from a closed state to an open state.

The excitation unit may comprise an electromagnetic coil and a drive mechanism mechanically connected with the normally closed contact. Under an action of a magnetic field generated when the electromagnetic coil is energized, the drive mechanism causes the normally closed contact to disconnect. Alternatively, the excitation unit may comprise a motor and a drive mechanism mechanically connected with the normally closed contact. Under an action of a torque generated when the motor is energized, the drive mechanism causes the normally closed contact to disconnect.

In addition to one or more of the aforementioned features, in the safety detection device, the second switch may be one of the following: a relay, a field effect transistor, and a bipolar transistor.

In addition to one or more of the aforementioned features, in the safety detection device, the controller may be configured to cause the safety detection device to periodically or non-periodically enter the second mode. Further, in the above-described case, duration of the second mode is a random value.

In addition to one or more of the aforementioned features, in the safety detection device, the controller may be configured to cause the safety detection device to enter the second mode with a period having a set change pattern. Further, in the above-described case, duration of the second mode is a fixed value or a random value.

In accordance with another aspect of the present disclosure, a provided escalator or moving walkway comprises one or more features of the safety detection device as described above.

### BRIEF DESCRIPTION OF THE DRAWINGS

The above and/or other aspects and advantages of the present disclosure will be clearer and more easily understood from the following description of various aspects in conjunction with the accompanying drawings, in which the same or similar units are denoted by the same reference numerals. The accompanying drawings include:

FIG. 1 is a view of an exemplary escalator or moving walkway.

FIG. 2 is a schematic view of a typical safety detection device for an escalator or moving walkway.

FIG. 3 is a timing diagram of signals collected at a control point C and a monitoring point M of the device shown in FIG. 2.

FIG. 4 is a schematic view of a safety detection device for an escalator or moving walkway in accordance with an embodiment of the present disclosure.

FIG. 5 is a timing diagram of signals collected at a control point C and a monitoring point M of the device shown in FIG. 4.

FIG. 6 is a schematic view of a safety detection device for an escalator or moving walkway in accordance with another embodiment of the present disclosure.

FIG. 7 is a schematic view of an escalator or moving walkway in accordance with another embodiment of the present disclosure.

FIG. 8 is a schematic block diagram of a controller.

### DETAILED DESCRIPTION OF THE INVENTION

The present disclosure is described more fully below with reference to the accompanying drawings, in which illustrative embodiments of the present disclosure are illustrated. However, the present disclosure may be implemented in different forms and should not be construed as limited to the embodiments presented herein. The presented embodiments are intended to make the disclosure herein comprehensive and complete, so as to more comprehensively convey the protection scope of the present disclosure to those skilled in the art.

In this specification, terms such as “comprising” and “including” mean that in addition to units and steps that are directly and clearly stated in the specification and claims, the technical solution of the present disclosure does not exclude the presence of other units and steps that are not directly or clearly stated in the specification and claims.

In this specification, terms such as “connection” and “connected” refer to an electrical connection for transmitting electricity, a communication connection for transmitting signals, and a mechanical connection for realizing a specific spatial positional relationship between two or more hardware entities, which include both cases where two hardware entities are directly connected and cases where two hardware entities are connected by other hardware entities. The specific meanings of the above terms herein may be determined by reference to the context.

In this specification, unless otherwise specified, terms such as “first” and “second” do not indicate the order of the units in time, space, size, etc., but are used only for distinguishing the units.

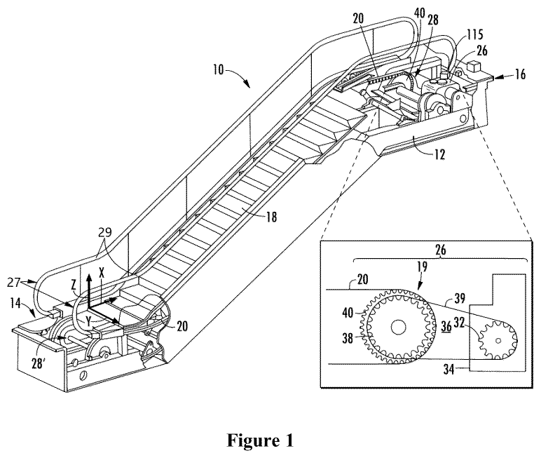

FIG. 1 illustrates an escalator 10. In the following description, it should become apparent that the present disclosure may be applicable to other passenger conveyor systems, such as moving walkways. The escalator 10 substantially includes a truss 12 extending between a lower station 14 and an upper station 16. A plurality of sequentially connected steps or treads 18 are connected to a step chain 20 and travel through a closed-loop path within the truss 12. Paired railings 22 include moving handrails 24. A drive machine 26 or drive system is typically positioned in a machine space 28 under the upper station 16. However, additional machine space 28′ may be positioned under the lower station 14. The drive machine 26 is configured to drive the treads 18 and/or handrails 24 via the step chain 20. The drive machine 26 operates to move the treads 18 in a selected direction at a desired speed under normal operating conditions.

The treads 18 make a 180-degree change in forward direction in a turning area 19 positioned under the lower station 14 and the upper station 16. The treads 18 are pivotally attached to the step chain 20 and follow a closed-loop path of the step chain 20, running from one landing station to another and back again.

The drive machine 26 includes a first drive mechanism 32, such as a motor output rope wheel, which is connected to a drive motor 34 via a belt reduction assembly 36. The belt reduction assembly 36 includes a second drive mechanism 38, such as an output rope wheel, which is driven by a tensioning member 39 such as an output belt. In some embodiments, the first drive mechanism 32 is a drive mechanism and the second drive mechanism 38 is a driven component.

As used herein, in a variety of embodiments, the first drive mechanism 32 and/or the second drive mechanism 38 may be any type of rotating device, such as a rope wheel, pulley, gear, wheel, sprocket, embedded tooth, pinion, and the like. In a variety of embodiments, the tensioning member 39 may be configured as a chain, belt, cable, strap, band, strip, or any other similar device that operatively connects two elements to provide a driving force from one element to the other. For example, the tensioning member 39 may be any type of interconnecting component that extends between the first drive mechanism 32 and the second drive mechanism 38 and operatively connects the first drive mechanism 32 and the second drive mechanism 38. In some embodiments, as illustrated in FIG. 1, the first drive mechanism 32 and the second drive mechanism 38 may provide belt reduction. For example, the first drive mechanism 32 may have an approximate diameter of 75 mm (2.95 inches) and the second drive mechanism 38 may have an approximate diameter of 750 mm (29.53 inches). For example, the belt reduction allows for replacement of rope wheel to vary speeds for 50 or 60 Hz supply power applications or different step speeds. However, in other embodiments, the second drive mechanism 38 may be substantially similar to the first drive mechanism 32.

As noted, the first drive mechanism 32 is driven by the drive motor 34 and is thus configured to drive the tensioning member 39 and the second drive mechanism 38. In some embodiments, the second drive mechanism 38 may be an idler gear or the like, which is driven with the aid of the tensioning member 39 by means of an operative connection between the first drive mechanism 32 and the second drive mechanism 38. The tensioning member 39 travels around a ring set by the first drive mechanism 32 and the second drive mechanism 38, which may hereinafter be referred to as a small ring. The small ring is provided for driving a larger ring, the larger ring includes the step chain 20 and driven by, for example, an output rope wheel 40. Under normal operating conditions, the tensioning member 39 and the step chain 20 move in unison based on the speed of movement of the first drive mechanism 32 driven, for example, by the drive motor 34.

The escalator 10 also includes a controller 115 in electronic communication with the drive motor 34. As shown, the controller 115 may be positioned in the machine space 28 of the escalator 10 and configured to control operation of the escalator 10. For example, the controller 115 may provide drive signals to the drive motor 34 to control acceleration, deceleration, stopping, and the like of the treads 18 via the step chain 20. The controller 115 may be an electronic controller including a processor and associated memory that includes computer executable instructions that, when executed by the processor, cause the processor to perform a variety of operations. The processor may be, but is not limited to, a single-processor or multi-processor system of any of a wide variety of possible architectures, which include field programmable gate array (FPGA), central processing unit (CPU), application-specific integrated circuit (ASIC), digital signal processor (DSP), or graphics processing unit (GPU) hardware arranged homogeneously or heterogeneously. The memory may be, but is not limited to, random access memory (RAM), read-only memory (ROM), or other electronic, optical, magnetic, or any other computer-readable medium.

Although described herein as specific escalator drive systems and specific components, this is merely exemplary, and those skilled in the art will recognize that moving walkways, as well as other escalators, may also be operated with the features or units disclosed herein.

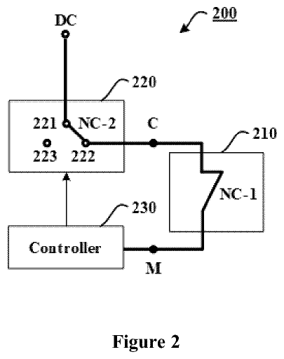

FIG. 2 is a schematic view of a typical safety detection device for an escalator or moving walkway. As shown in FIG. 2, a safety detection device 200 includes a floor switch 210, a relay 220, and a controller 230. The controller 230 may be implemented using components, such as, a microprocessor-based controller, an application-specific integrated circuit (ASIC), a field-programmable gate array (FPGA), etc. Exemplarily, the floor switch is disposed under a front panel, and the relay 220 and the controller 230, as well as other circuitry elements (e.g., resistors and capacitors, etc.) are disposed on a printed circuit board (which is also referred to as a “control board”).

In some examples, the floor switch 210 includes normally closed contacts NC-1 as a switch element, the pair of contacts being connected to a contact 222 of the relay 220 and the controller 230, respectively. The floor switch 210 also includes a mechanical triggering mechanism (not shown) that will drive the normally closed contacts to disconnect when the front panel is opened or taken away, which in turn activates the safety circuit containing the controller 230 to stop operating the escalator or moving walkway.

In the relay 220, contacts 221 and 222 form normally closed contacts NC-2. Under the control of the controller 230, the normally closed contacts NC-2 may be disconnected and contacts 221 and 223 closed. In addition, the contact 221 is connected to a DC voltage source DC.

The safety detection device 200 shown in FIG. 2 may operate in an operating mode and a test mode. In the operating mode, the normally closed contacts NC-2 of the relay 220 are in a closed state and a signal at a control point C is a high level signal. At this time, if no abnormal event occurs (the abnormal event includes, for example, the front panel being opened or taken away, etc.), the normally closed contacts NC-1 of the floor switch 210 are also in a closed state, and thus a signal at a monitoring point M and a signal input of the controller 230 is a high level signal. On the other hand, if the abnormal event occurs, the normally closed contacts NC-1 of the floor switch 210 is disconnected by the action of the mechanical triggering mechanism, thereby presenting a low level signal at the monitoring point M and the signal input of the controller 230, whereby the controller 230 may determine that an abnormality has occurred and perform corresponding fault handling logic to stop operating the escalator or moving walkway.

In the test mode, the normally closed contacts NC-2 are disconnected under the control of the controller 230. At this point the controller 230 may perform corresponding self-test logic to determine if a function of the control board is normal. However, in the device shown in FIG. 2, the functionality of the floor switch 210 cannot be tested. For example, the self-test logic described above is not capable of detecting functional abnormalities due to short circuits, sticking or other faults within the floor switch 210.

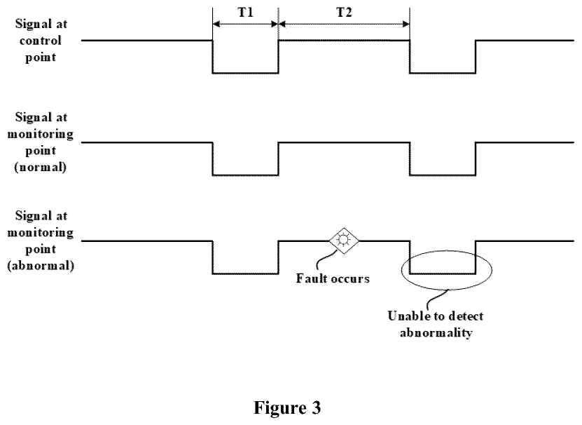

FIG. 3 is a timing diagram of signals collected at the control point C and the monitoring point M of the device shown in FIG. 2. Combining FIGS. 2 and 3, when the normally closed contacts NC-2 are in the closed state, the collected signals at both the control point C and the monitoring point M are at a high level, whereas when the normally closed contacts NC-2 are disconnected, the collected signals at both the control point C and the monitoring point M are at a low level, regardless of whether or not a fault occurs at the floor switch which is incapable of switching to the disconnected state. In other words, a functional abnormality of the floor switch cannot be determined from the collected signal at the monitoring point.

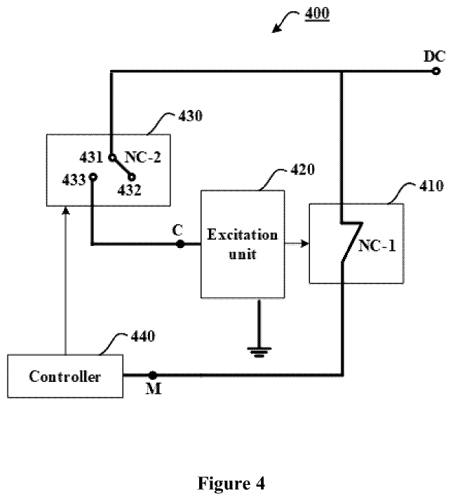

FIG. 4 is a schematic view of a safety detection device for an escalator or moving walkway in accordance with an embodiment of the present disclosure. A safety detection device 400 shown in FIG. 4 includes a floor switch 410, an excitation unit 420, a relay 430, and a controller 440. Exemplarily, the floor switch 410 is disposed under a front panel or cover plate of an escalator, a drive mechanism (e.g., push rod) of the excitation unit 420 is mechanically connected with the floor switch 410, and the relay 430 and the controller 440, as well as other circuitry elements are disposed on a control board, which control board may be deployed in a bottom control cabinet or motor box.

In this embodiment, the floor switch 410 includes normally closed contacts NC-1 and a mechanical triggering mechanism (not shown). Referring to FIG. 2, the normally closed contacts NC-1 are connected to a DC voltage source DC and the controller 440, respectively. When the front panel is opened or taken away, the mechanical triggering mechanism will perform a corresponding action, which causes the normally closed contacts NC-1 to disconnect.

One end of the excitation unit 420 is connected to a contact 433 of the relay 430 and the other end is grounded. When the excitation unit 420 is energized, the normally closed contacts NC-1 as a switch element are caused to be disconnected with the aid of the drive mechanism.

In some examples, the excitation unit 420 includes an electromagnetic coil and a drive mechanism mechanically connected with the normally closed contacts NC-1. When the electromagnetic coil is energized, a magnetic field it generates causes the drive mechanism to move, thereby driving the normally closed contacts NC-1 to disconnect. In some other examples, the excitation unit 420 includes a motor and a drive mechanism mechanically connected with the normally closed contacts NC-1. When the motor is energized, a torque it generates causes the drive mechanism to move, thereby driving the normally closed contacts NC-1 to disconnect.

Exemplarily, the relay 430 includes contacts 431, 432, and 433, wherein the contacts 431 and 432 form normally closed contacts NC-2. Under the control of the controller 440, the normally closed contacts NC-2 may be disconnected and the contacts 431 and 433 are closed. As shown in FIG. 4, the contact 431 is connected to the DC voltage source DC.

The safety detection device 400 shown in FIG. 4 may operate in an operating mode and a test mode. In the operating mode, the normally closed contacts NC-2 of the relay 430 are in a closed state. Similar to the device shown in FIG. 2, if no abnormal event occurs, the normally closed contacts NC-1 of the floor switch 410 are also in a closed state. Accordingly, a high level signal is presented at the monitoring point M and the signal input of the controller 440. On the other hand, if the abnormal event occurs, the normally closed contacts NC-1 of the floor switch 410 will be disconnected, thereby presenting a low level signal at the monitoring point M and the signal input of the controller 440. The controller 440 performs corresponding fault handling logic in response to the low level signal.

In the test mode, under the control of the controller 440, the normally closed contacts NC-2 are disconnected and the contacts 431 and 433 are closed, at which time the controller 440 may detect the functionality of the floor switch 410 in addition to performing corresponding self-test logic to determine if a function of the control board is normal. Specifically, in the test mode, the excitation unit 420 is energized, and in the event that the function of the floor switch 410 is normal, the normally closed contacts NC-1 will be disconnected, thus presenting a low level signal at the monitoring point M and the signal input of the controller 440, and the controller 440 may thereby determine that the function of the floor switch 410 is normal. On the other hand, if the floor switch 410 cannot be switched to the disconnected state due to short circuits, sticking or other faults within the floor switch 410, a high level signal will be presented at the monitoring point M and the signal input of the controller 440, and thus it is determined that the function of the floor switch 410 is abnormal.

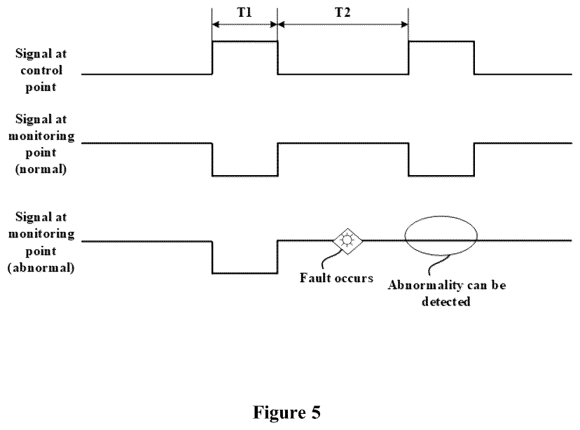

FIG. 5 is a timing diagram of signals collected at the control point C and the monitoring point M of the device shown in FIG. 4. Combining FIGS. 4 and 5, when the normally closed contacts NC-2 are in the closed state, the collected signal at the control point C is low level and the collected signal at the monitoring point M is high level. When the normally closed contacts NC-2 are disconnected such that the contacts 431 and 433 are closed or contacted, the collected signal at the control point C will change to a high level. At this time, if the function of the floor switch 410 is normal, the floor switch 410 will switch from the closed state to the open state under the action of the excitation unit 420, and thus the collected signal at the monitoring point M will change to a low level, whereby the controller 440 may determine that the function of the floor switch is normal. On the other hand, when the function of the floor switch 410 is abnormal, the floor switch 410 will not complete the switch from the closed state to the open state under the action of the excitation unit 420, and thus the collected signal at the monitoring point M will remain high level, whereby the controller 440 may determine that the function of the floor switch is abnormal.

In some examples, the controller 440 may cause the device 400 to periodically enter the test mode. Taking FIG. 5 as an example, the duration T1 indicates the duration of time that the device 400 is in the test mode, and the duration T2 indicates the duration of time that the device 400 is in the operating mode (i.e., the time interval between two that entries into the test mode). Periodic testing of the function of the device 400 can be realized by causing the duration T2 to remain unchanged, and non-periodic testing of the function of the device 400 can be realized by causing the duration T2 to vary randomly or with a set change pattern. In these examples, the duration T1 may be fixed, or may vary randomly or with a set change pattern. For example, the duration T1 may be a randomly selected value from a range of values. As for the range of values, it may be determined by simulation experiments or based on historical operational data of the safety detection device. In some cases, the faults of the floor switch may be somewhat self-healing (e.g. a fault occurs when the cover plate opens and closes and sometimes behaves as functioning normally). Such faults with self-healing characteristics can be detected with greater probability by periodically entering the test mode but selecting a random length of duration for the test mode than by keeping both durations T1 and T2 constant.

In some other examples, the controller 440 may cause the duration T1 or T2 to vary with a set change pattern. Still using FIG. 5 as an example, the time interval T2 between two that entries into the test mode may start from an initial value and increase or decrease in a linear or non-linear manner to an end value, and then proceed to the next cycle, again starting from the initial value and increasing or decreasing in a linear or non-linear manner to the end value. As for the form of the linear or non-linear manner, it may be determined by simulation experiments or based on historical operational data of the safety detection device. For the duration T1, it may also be varied with a set change pattern in a manner similar to that described above. The faults with self-healing characteristics can also be detected with greater probability by varying the time interval T2 with a set change pattern and keeping the duration T1 constant than by keeping both durations T1 and T2 constant.

In the embodiment shown in FIG. 4, the relay 430 may be seen as a controlled switch connected between the DC power supply DC and the excitation unit 420, which, under the control of the controller 440, exerts control over energizing and de-energizing the excitation unit 420. In some forms of modification to this embodiment, other switch elements may also be utilized in place of the relay to achieve the function of the controlled switch, and examples of these switch elements include, but are not limited to, field effect transistors and bipolar transistors, among others.

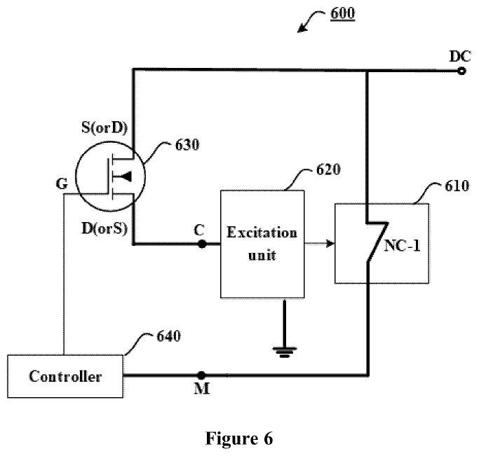

FIG. 6 is a schematic view of a safety detection device for an escalator or moving walkway in accordance with another embodiment of the present disclosure. In order to avoid redundancy, the following description will focus on the differences from the embodiment shown in FIG. 4. It is noted that, without conflicting with these differences, this embodiment may include various features of the embodiment shown in FIG. 4.

A safety detection device 600 shown in FIG. 6 includes a floor switch 610, an excitation unit 620, a field effect transistor 630, and a controller 640. In this embodiment, the floor switch 610 includes normally closed contacts NC-1 and a mechanical triggering mechanism (not shown), where the normally closed contacts NC-1 are connected to a DC voltage source DC and the controller 640, respectively. When the front panel of the escalator is opened or taken away, the mechanical triggering mechanism will perform a corresponding action, which causes the normally closed contacts NC-1 to close. When the excitation unit 620 is energized, the normally closed contacts NC-1 as a switch element are caused to close with the aid of the drive mechanism.

Exemplarily, as shown in FIG. 6, a source S (or drain D) of the field effect transistor 630 is connected to the DC power supply DC, a drain D (or source S) is connected to the excitation unit 620 (e.g., the included solenoid), and a gate G is connected to the controller 640. Depending on the different types of majority carriers, the controller 640 may control the conduction and turn-off of the field effect transistor 630 by applying a high or low level signal to the gate G of the field effect transistor 630.

The safety detection device 600 shown in FIG. 6 may likewise operate in an operating mode and a test mode. In the operating mode, the field effect transistor 630 is in a turn-off state. If no abnormal event occurs, the normally closed contacts NC-1 of the floor switch 610 are in a closed state. Accordingly, a high level signal is presented at the monitoring point M and the signal input of the controller 640. On the other hand, if the abnormal event occurs, the normally closed contacts NC-1 of the floor switch 610 will be disconnected, thereby presenting a low level signal at the monitoring point M and the signal input of the controller 640.

In the test mode, under the control of the controller 640, the field effect transistor 630 is in a conduction state, at which time the excitation unit 620 is energized, and in the event that the function of the floor switch 610 is normal, the normally closed contacts NC-1 will be disconnected, thus presenting a low level signal at the monitoring point M and the signal input of the controller 640 (e.g., also shown in FIG. 5), and the controller 640 may thereby determine that the function of the floor switch 610 is normal. On the other hand, if the floor switch 610 cannot switch from the closed state to the disconnected state, a high level signal will be maintained at the monitoring point M and the signal input of the controller 640 (e.g., also shown in FIG. 5), and thereby it is determined that the function of the floor switch 610 is abnormal.

Compared to the safety detection device shown in FIG. 2, the above embodiments of the present disclosure, as well as their variant forms, are not only capable of detecting whether the function of the control board is normal, but can also be extended to detect the functionality of the floor switch, thereby improving the safety detection capability. Furthermore, the safety detection device in accordance with the above-described embodiments and variations thereof can be realized with only minor changes to the device shown in FIG. 2 (e.g., by adding a small number of wires and by adding an excitation unit), and thus is suitable for upgrading an existing device, and also reduces the cost of the modification.

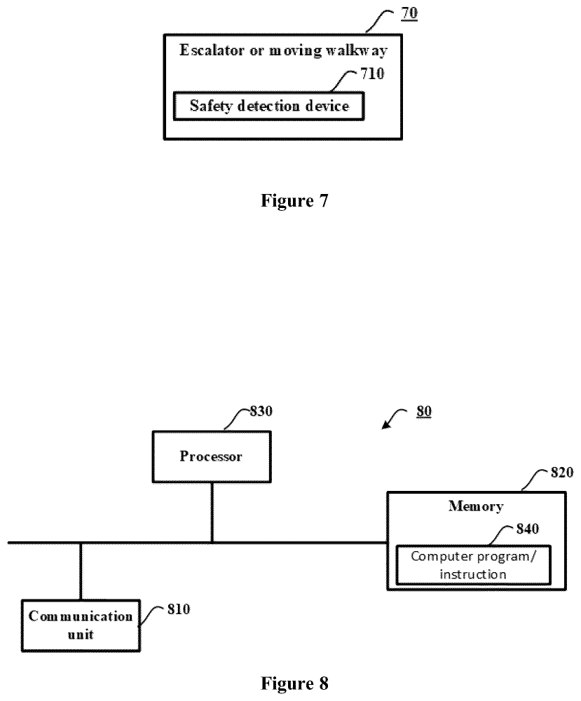

FIG. 7 is a schematic view of an escalator or moving walkway in accordance with another embodiment of the present disclosure. An escalator or moving walkway 70 shown in FIG. 7 may comprise the structures, features, or variations thereof shown in FIG. 1. In addition, the escalator or moving walkway 70 also comprises a safety detection device 710, which may comprise the structure, features, or variations thereof of the embodiments described above with the aid of FIGS. 4-6.

FIG. 8 is a schematic block diagram of a controller 80. A controller 80 shown in FIG. 8 may, for example, be used to implement a controller in an elevator system (e.g., the controller 115 in FIG. 1) or a safety controller, etc.

As shown in FIG. 8, the controller 80 comprises a communication unit 810 (e.g., a network interface card), one or more memory 820 (e.g., non-volatile memories such as flash memory, ROM, hard drives, disks, CD-ROMs, and the like), one or more processor 830, and a computer program/instruction 840.

The communication unit 810 serves as a communication interface configured to receive control commands, data, and status signals from external devices (e.g., other units of the elevator system (e.g., the floor switch of FIGS. 4, 6, etc.) or networks (e.g., the Internet and wireless LANs, etc.)), and to send control commands, data, and drive signals generated at the controller 80 to external devices (e.g., the relay of FIG. 4 and the field effect transistor 630 of FIG. 6) or networks.

The memory 820 stores the computer program/instruction 840 that may be executed by the processor 830. In addition, the memory 820 may also store data generated by the processor 830 in executing the computer program/instruction 840 and data received from external devices (e.g., level signals of the monitoring point M, etc.) via the communication unit 810.

The processor 830 is configured to execute the computer program/instruction 840 stored on the memory 820 and perform access operations to the memory 820.

The computer program/instruction 840 may include computer instruction for implementing various functions and operations described with the aid of FIGS. 4 to 7, enabling the functions and operations to be implemented by executing the computer program/instruction 840 on the processor 830.

Those skilled in the art will appreciate that various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present disclosure.

Although only a few of the specific embodiments of the present disclosure have been described, those skilled in the art will appreciate that the present disclosure may be embodied in many other forms without departing from the spirit and scope thereof. Accordingly, the examples and implementations shown are to be regarded as illustrative and not restrictive, and various modifications and substitutions may be covered by the present disclosure without departing from the spirit and scope of the present disclosure as defined by the appended claims.

The embodiments and examples presented herein are provided to best illustrate embodiments in accordance with the present technology and its particular application, and to thereby enable those skilled in the art to implement and use the present disclosure. However, those skilled in the art will appreciate that the above description and examples are provided for convenience of illustration and example only. The presented description is not intended to cover every aspect of the present disclosure or to limit the present disclosure to the precise form disclosed.

What is claimed is:

1. A safety detection device for an escalator or moving walkway, comprising:
a first switch, which is provided under a cover plate and one end of which is connected to a power supply, and which switches from a first state to a second state in response to an abnormal event;
an excitation unit which, when energized, causes the first switch to switch from the first state to the second state;
a second switch connected between the power supply and the excitation unit; and
a controller configured to:
in a first mode, disconnect a connection between the power supply and the excitation unit by controlling the second switch and determine whether the abnormal event occurs based on a voltage at other end of the first switch;
in a second mode, connect the power supply with the excitation unit by controlling the second switch, and determine whether a function of the first switch is normal based on the voltage at the other end of the first switch.

2. The safety detection device of claim 1, wherein the first switch comprises a normally closed contact and a triggering mechanism, the triggering mechanism causes the normally closed contact to disconnect in response to the abnormal event, causing the first switch to switch from a closed state as the first state to an open state as the second state.

3. The safety detection device of claim 2, wherein the excitation unit comprises an electromagnetic coil and a drive mechanism mechanically connected with the normally closed contact, the drive mechanism causes the normally closed contact to disconnect under an action of a magnetic field generated when the electromagnetic coil is energized.

4. The safety detection device of claim 2, wherein the excitation unit comprises a motor and a drive mechanism mechanically connected with the normally closed contact, the drive mechanism causes the normally closed contact to disconnect under an action of a torque generated when the motor is energized.

5. The safety detection device of claim 1, wherein the second switch is one of the following: a relay, a field effect transistor, and a bipolar transistor.

6. The safety detection device of claim 1, wherein the controller is further configured to cause the safety detection device to periodically or non-periodically enter the second mode.

7. The safety detection device of claim 6, wherein duration of the second mode is a random value.

8. The safety detection device of claim 1, wherein the controller is further configured to cause the safety detection device to enter the second mode with a period having a set change pattern.

9. The safety detection device of claim 8, wherein duration of the second mode is a fixed value or a random value.

10. An escalator or moving walkway, comprising the safety detection device as claimed in claim 1.
